(19) United States
(12) Patent Application Publication
(10) Pub. No.: US 2025/0363507 A1
(43) Pub. Date: Nov. 27, 2025

(54) EVALUATING EDGES OF COLLAPSED IDENTITY GRAPHS FOR IDENTITY RESOLUTION

(71) Applicant: ADOBE INC., San Jose, CA (US)

(72) Inventors: Shota IDO, San Jose, CA (US); Sai Venkatesh KADIYALA, San Jose, CA (US); Rahul BISWAS, San Jose, CA (US); Mansi ANAND, Sunnyvale, CA (US); Mandeep GANDHI, Bangalore (IN); Kiran Kumar REDDY, San Jose, CA (US); Harikrishnan BHASKARAN, Monte Sereno, CA (US)

(21) Appl. No.: 18/672,990

(22) Filed: May 23, 2024

(51) Int. Cl. G06Q 30/0201

(52) U.S. Cl. CPC G06Q 30/0201

(57) ABSTRACT

Methods and systems are provided for evaluating edges of collapsed identity graphs for identity resolution. In embodiments described herein, a collapsed state of identity graphs, such as based on an identity namespace limit being exceeded by the identity graphs, is determined by applying an identity node and edge of an incoming record to the identity graphs. A temporary state of the identity graphs is determined by pruning edges of the collapsed state. A non-collapsed state of the identity graphs that includes the edge of the incoming record is determined by applying the edge of the incoming record to the temporary state. A different edge is determined to be pruned from the non-collapsed state as when the different edge is applied to the temporary state with the edge of the incoming record, the temporary state collapses into the collapsed state. An identity graph is updated based on the non-collapsed state.

### BACKGROUND

Identity resolution is the process of linking multiple identities (e.g., customer accounts, email addresses, device IDs, browser IDs, etc.) across various platforms to a single individual, such as a customer of a business. Among other applications, identity resolution enables businesses to determine whether a customer interacted with a business, such as when a customer navigates to a product website using a device associated with the customer, through one of the identities associated with the customer. The business can then build a comprehensive customer profile for the customer to optimize personalized and/or targeted marketing strategies.

### SUMMARY

Various aspects of the technology described herein are generally directed to systems, methods, and computer storage media for, among other things, evaluating edges of collapsed identity graphs for identity resolution. In this regard, embodiments described herein facilitate evaluating edges of collapsed identity graphs for identity resolution by evaluating properties (e.g., time and priority) of the edges of the collapsed identity graphs. By automatically evaluating properties (e.g., time and priority) of the edges of the collapsed identity graphs to resolve the collapsed identity graphs in an efficient and effective manner, an identity graph of a customer can be updated based on the most up-to-date customer data. For example, identity nodes and edges of an incoming customer interaction record are applied to an identity graph associated with a customer, which causes the identity graph of the customer to collapse with a different identity graph associated with a different customer. The edges of the collapsed state of the identity graphs are pruned resulting in a temporary state of the identity graphs. In some embodiments, the identity resolution component initially re-applies each of the edges to the temporary state of the identity graphs that are non-incident to the identity nodes of the incoming customer interaction record. The identity resolution component re-applies the edges of the incoming customer interaction record to the temporary state of the identity graphs to determine whether the edge should be included in the non-collapsed state of the identity graphs. Subsequent to the identity resolution component re-applying edges of the incoming customer interaction record, the remaining edges are applied in order of priority value to determine whether the edge should be included in the non-collapsed state of the identity graphs. After the identity resolution component re-applies each of the edges to the temporary state of the identity graphs and permanently prunes any edges that result in a collapsed state of the identity graphs, the identity resolution component determines a non-collapsed state of the identity graphs.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram for evaluating edges of collapsed identity graphs for identity resolution, in accordance with embodiments of the present disclosure.

FIGS. 4A-4F provides an example of evaluating edges of collapsed identity graphs for identity resolution, in accordance with embodiments of the present disclosure.

FIGS. 5A-5C provides another example of evaluating edges of collapsed identity graphs for identity resolution, in accordance with embodiments of the present disclosure.

FIG. 6 is a process flow showing a method for evaluating edges of collapsed identity graphs for identity resolution, in accordance with embodiments of the present disclosure.

FIG. 7 is a process flow showing another method for evaluating edges of collapsed identity graphs for identity resolution, in accordance with embodiments of the present disclosure.

FIG. 8 is a block diagram of an example computing device in which embodiments of the present disclosure can be employed.

### DETAILED DESCRIPTION

Identity resolution is the process of linking multiple identities (e.g., customer accounts, email addresses, device IDs, browser IDs, etc.) across various platforms to a single individual, such as a customer of a business, even when they occur through different channels. Among other applications, identity resolution enables businesses to determine whether a customer interacted with a business, such as when a customer navigates to a product website using a device associated with the customer, through one of the identities associated with the customer. The business can then build a comprehensive customer profile for the customer, including demographic information, behavior data, transaction history, and/or any other customer data collected for the customer. The customer profile can then be used by the business to optimize personalized and/or targeted marketing strategies and maintain customer loyalty in a multi-channel environment.

An identity graph provides a mapping of relationships between different identities (e.g., represented as an identity node) of a particular individual. For example, an identity graph is a data structure, such as a table in a database, knowledge graph, and/or other data structure, that maps and visualizes the relationships between various identities associated with a particular customer across multiple platforms and touchpoints. An identity graph includes identity nodes, which represent unique identities, such as email addresses, phone numbers, User IDs, Device IDs, Transaction IDs, Cookie IDs, Addresses, social media profiles, zip codes, etc. and edges, which depict the relationships or connections between identity nodes (e.g., linking an individual's email address to their phone number, which indicates the identifiers belong to the same individual).

Each identity node includes an identity namespace and an identity value, such as an identity namespace for “Email”, and an identity value of “john@email.com”. Each edge can include various properties regarding the relationship between the identity nodes, such as properties related to events establishing the relationship between the identity nodes (e.g., a first established timestamp and a last updated timestamp). The first established timestamp of an edge can include the date and time at which a new identity node is linked to an existing identity node. The last updated timestamp can include the date and time at which an existing link between identity nodes was last updated (e.g., by a subsequent event for the particular customer). For example, the first established timestamp of an edge between a device ID and a customer ID may indicate the first time that a customer navigates to a product website using a device associated with the device ID while logged in with the customer ID. The last updated timestamp of an edge between a device and a customer ID may indicate the most recent time the customer navigates to the product website using the device associated with the device ID while logged in with the customer ID.

Due to scenarios where two or more customers are associated with a single identity, each identity graph of the two or more customers can collapse into a single identity graph shared between the two or customers (e.g., a collapsed state of the identity graphs). Scenarios where two or more customers are associated with a single identity can include a shared device scenario, bad identity value scenarios, and/or others. Examples of shared device scenarios include (1) customers sharing a common device, such as a home laptop to access their individual back account; (2) when a customer representative logs in on behalf of a customer during a customer call, all customers handled by that customer representative can be treated as the same person; and (3) when customers use a self-service kiosk, to place an orders (e.g., to order food at a restaurants), check-ins (e.g., hotels, car rental etc.), and/or others, all customers can be associated with the self-service kiosk. Examples of bad identity value scenarios include (1) when customers use non-unique values such as test@test.com as an email, 1-111-1111, as a phone number, etc. in order to create an account, which can result in all of the identity graphs of the customers with the non-unique values collapsing; (2) when bad or erroneous data is entered, such as a customer ID namespace with identity value “user_null” or a phone namespace with identity value “undefined,” can result in all of the identity graphs of the customers with the bad or erroneous data collapsing.

The collapsing of identity graphs of two or more customers into a single identity graph can result in undesired customer experiences, such as mistaken identities, misleading analytics, and ineffective personalization efforts by showing wrong advertisements and targeting incorrect campaigns. The undesired customer experiences can impact brand reputation, cause potential customer and revenue loss, and can result in legal complications for certain industries, such as healthcare and financial services.

Similarly, ignoring the incoming identity nodes that caused the graph to collapse or duplicating the incoming identity nodes for the two or more customers can also cause undesirable customer experiences. Typically, businesses desire the most up-to-date customer data to optimize personalized and/or targeted marketing strategies. However, if the incoming identity nodes that caused the graph to collapse is ignored, the most up-to-date information is ignored resulting in undesired customer experiences based on stale customer data (e.g., as the customer data is outdated and no longer accurate). If the incoming identity nodes are duplicated for the two or more customers, one of the customers will be provided undesired customer experiences based on stale customer data.

Currently, in order to apply the most up-to-date customer data for identity resolution of collapsed identity graphs, a user must manually access customer data to manually determine the most up-to-date customer data, manually access the customer data to manually determine the stale customer data that causes the identity graphs to collapse when the most up-to-date customer data is utilized, and manually delete the stale customer data that causes the identity graphs to collapse causing the deletion of the corresponding identity nodes from an identity graph. However, in manually deleting the stale customer data, the user loses the customer data from the corresponding customer profile of the customer resulting in undesirable customer experience when all of the customer's interaction are not present in the customer profile. Not only does the manual process of determining and deleting the stale customer data provide inaccurate customer profiles and identity graphs, the manual process unnecessarily increases the usage of computing and network resources.

Accordingly, unnecessary computing resources are utilized to manually apply the most up-to-date customer data for identity resolution of collapsed identity graphs. For example, computing and network resources are unnecessarily consumed to facilitate the manual access of customer data to manually determine the most up-to-date customer data, manual access of customer data to manually determine the stale customer data that causes the identity graphs to collapse when the most up-to-date customer data is utilized, and manual access of customer data to manually delete the stale customer data that causes the identity graphs to collapse causing the deletion of the corresponding identity nodes from an identity graph. For instance, computer input/output operations are unnecessarily increased to manually apply the most up-to-date customer data for identity resolution of collapsed identity graphs. Further, when the dataset is located in a disk array, there is unnecessary wear placed on the read/write head of the disk of the disk array to apply the manual operations to manually apply the most up-to-date customer data for identity resolution of collapsed identity graphs. Even further, the processing of operations to manually apply the most up-to-date customer data for identity resolution of collapsed identity graphs decreases the throughput for a network, increases the network latency, and increases packet generation costs when the customer data is located over a network.

As such, embodiments of the present disclosure are directed to evaluating edges of collapsed identity graphs for identity resolution in an efficient and effective manner. In this regard, the most up-to-date customer data can be efficiently and effectively implemented for identity resolution based on properties of the edges, such as the time and priority of the edges, of the collapsed identity graphs.

Generally, and at a high level, embodiments described herein facilitate evaluating edges of collapsed identity graphs for identity resolution by evaluating properties (e.g., time and priority) of the edges of the collapsed identity graphs. In this regard, by automatically evaluating properties (e.g., time and priority) of the edges of the collapsed identity graphs to resolve the collapsed identity graphs in an efficient and effective manner, an identity graph of a customer can be updated based on the most up-to-date customer data. For example, identity nodes and edges of an incoming customer interaction record are applied to an identity graph associated with a customer, which causes the identity graph of the customer to collapse with a different identity graph associated with a different customer. The edges of the collapsed state of the identity graphs are pruned resulting in a temporary state of the identity graphs. In some embodiments, the identity resolution component initially re-applies each of the edges to the temporary state of the identity graphs that are non-incident to the identity nodes of the incoming customer interaction record. The identity resolution component re-applies the edges of the incoming customer interaction record to the temporary state of the identity graphs to determine whether the edge should be included in the non-collapsed state of the identity graphs. Subsequent to the identity resolution component re-applying edges of the incoming customer interaction record, the remaining edges are applied in order of priority value to determine whether the edge should be included in the non-collapsed state of the identity graphs. After the identity resolution component re-applies each of the edges to the temporary state of the identity graphs and permanently prunes any edges that result in a collapsed state of the identity graphs, the identity resolution component determines a non-collapsed state of the identity graphs.

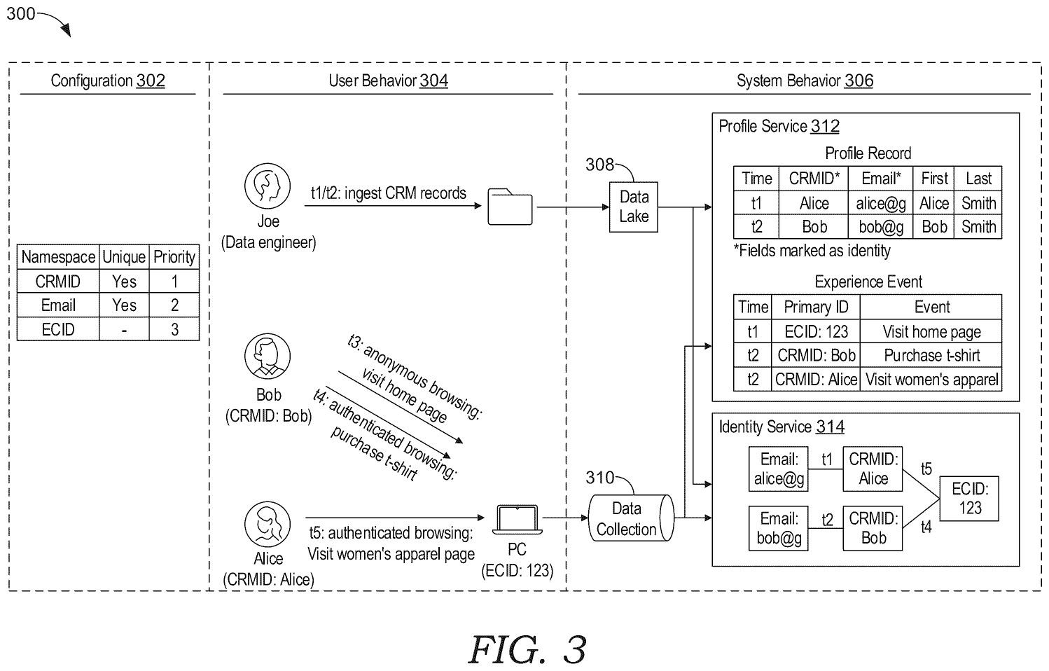

In operation, an incoming customer interaction record is accessed by an identity graph component. The customer interaction record includes data regarding the customer interaction event, such as the identity value and identity namespace of the identities (e.g., the device ID and the customer account ID), timestamp data indicating when the customer interaction event occurred, and/or any other customer data regarding the interaction (e.g., logging into the account, browsing or performing an action). For example, a customer logs into their customer account through a computing device. A “customer” generally refers to a customer or potential customer of a business (e.g., the business builds a corresponding customer profile of the customer). A “user” generally refers to a user implementing personalized and/or targeted marketing strategies on behalf of a business (e.g., based on the customer profile of the customer). The device ID of the computing device and customer account ID, the time that the customer logged in, and data indicating the interaction of the customer logging in are collected by a data collection component as a customer interaction record. In some embodiments, the data regarding the customer interaction record is collected by a data collection component in communication with an identity graph component. In some embodiments, the data regarding the incoming record is stored in data store (e.g., from a customer relationship management (CRM) system as shown in FIG. 3) and accessed by the identity graph component.

The identity graph component applies identity nodes (e.g., a first identity node indicating the identity value and identity namespace of the device ID and a second identity node indicating the identity value and identity namespace of the customer account ID) and edge(s) (e.g., relationship between the first identity node and the second identity node with timestamp data indicating the time that the customer logged in) of the incoming customer interaction record to an identity graph associated with the customer.

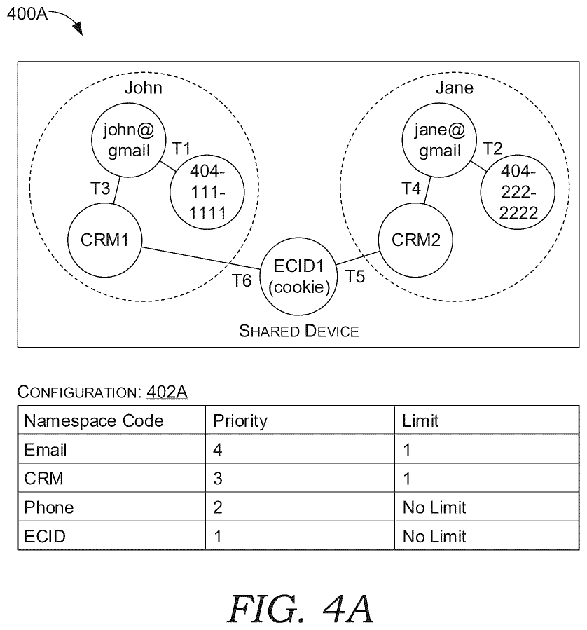

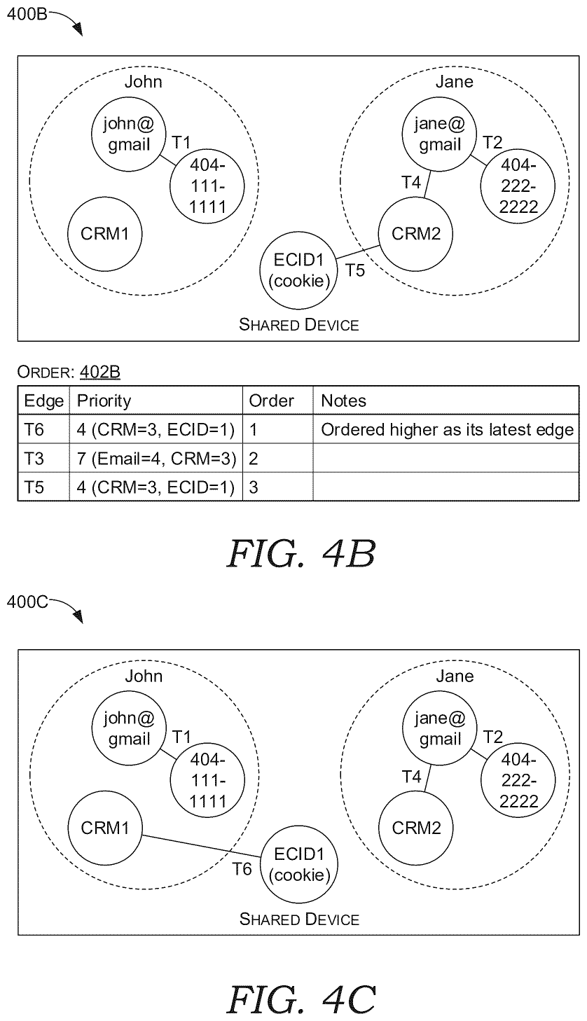

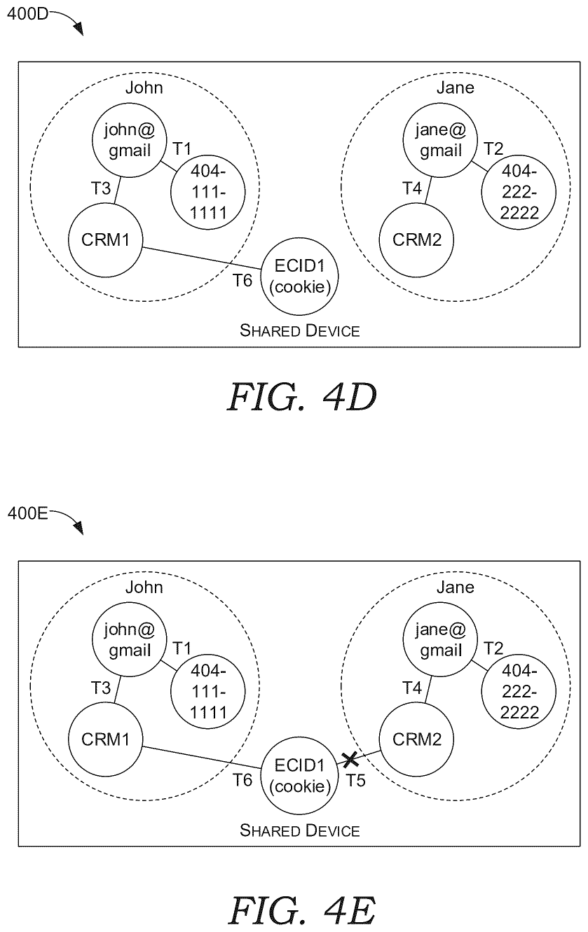

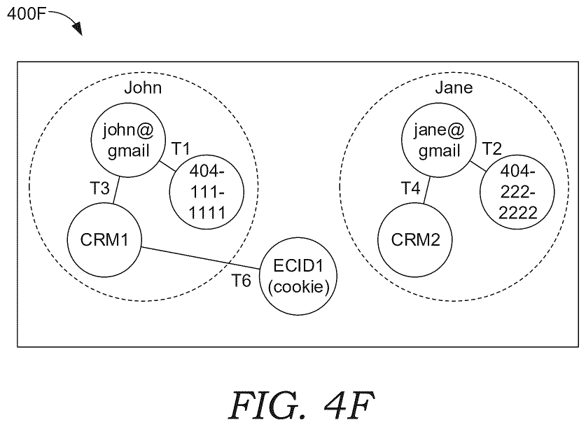

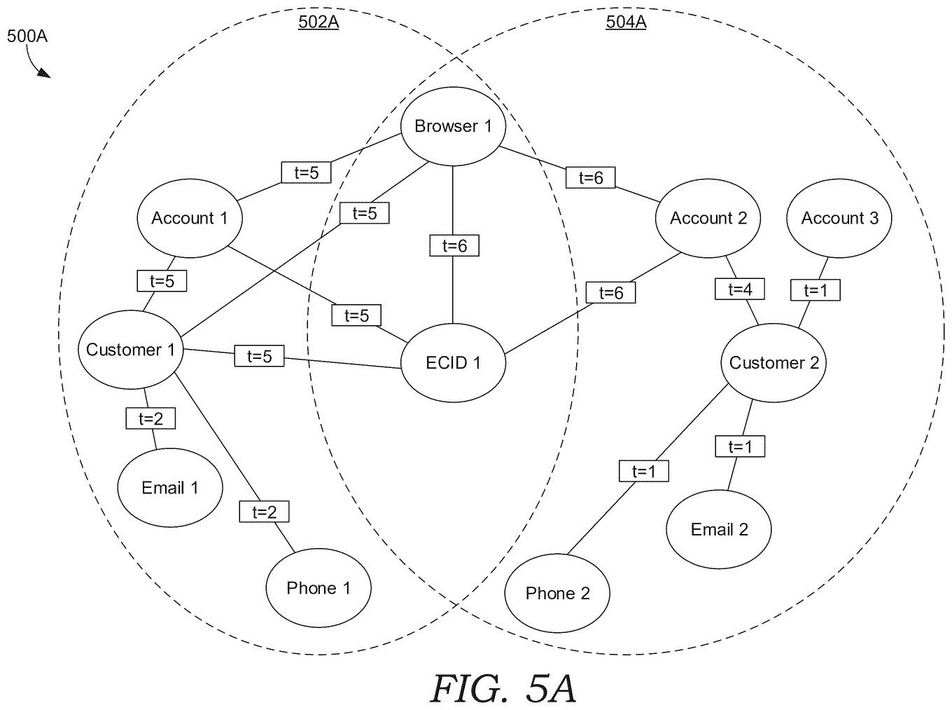

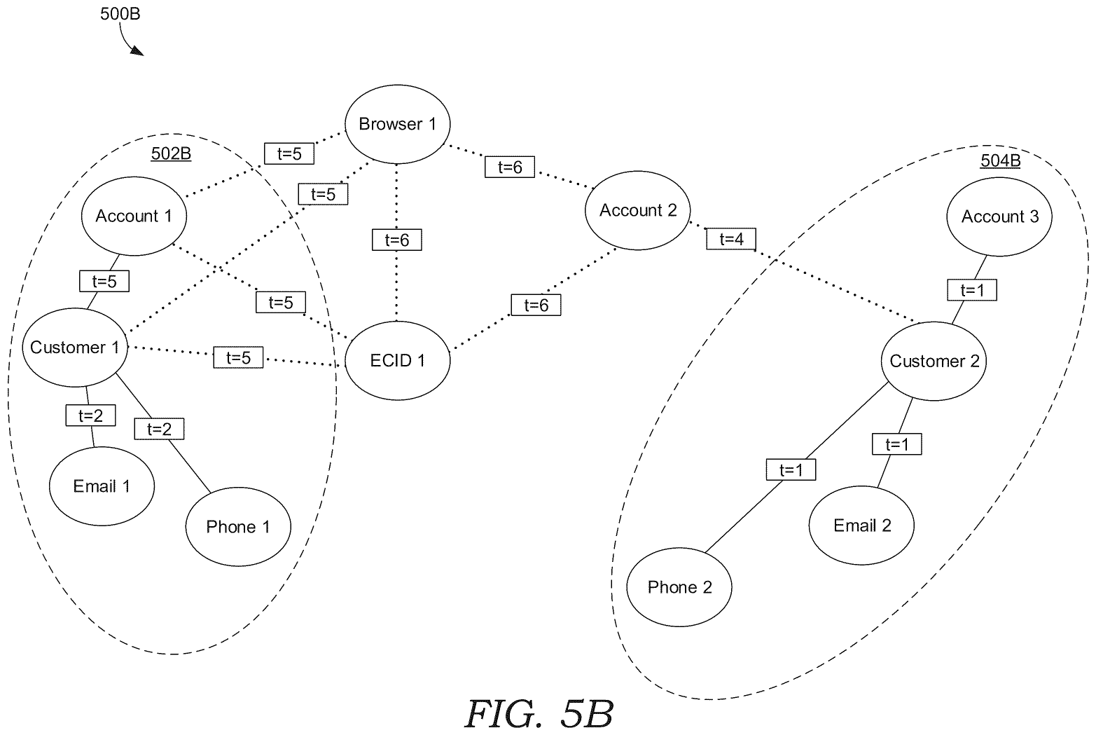

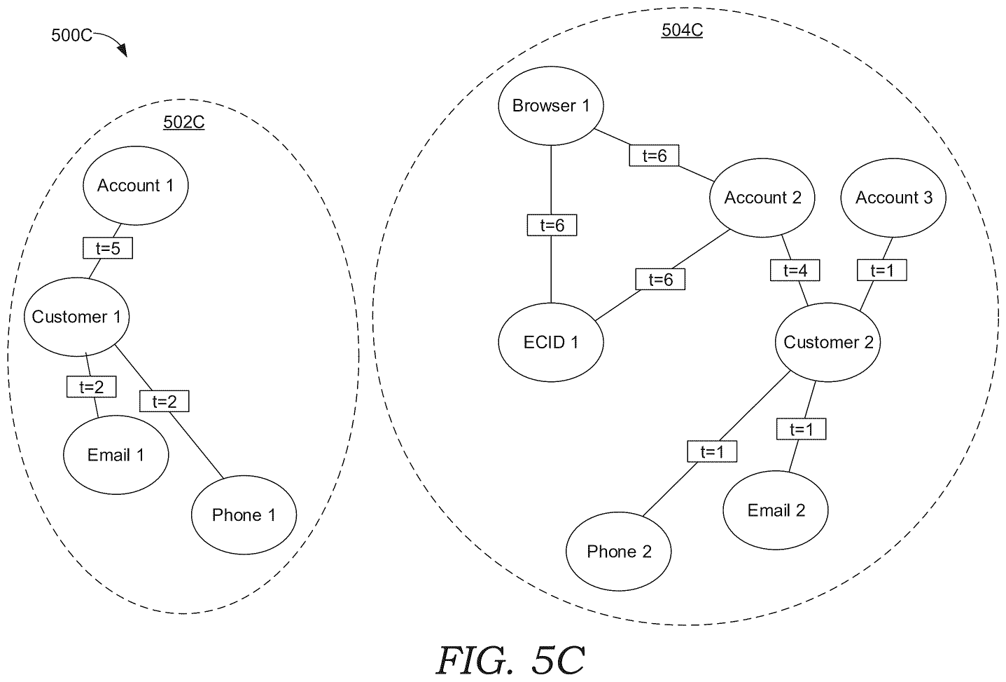

An identity resolution component determines that the identity nodes and edge(s) of the incoming customer interaction record causes the identity graph of the customer to collapse with a different identity graph associated with a different customer resulting in a collapsed state of the identity graphs. For example, the computing device was previously used to log in to a different customer account by a different customer. As such, the identity graph of the different customer includes an edge indicating a relationship between the identity node of the computing device (e.g., the device ID) and the identity node of the different customer account (e.g., a different customer account ID). In this regard, the identity graph of the two customers collapse into a single graph as both the identity node of the customer account and the identity node of the different customer account are connected by corresponding edges to the identity node of the identity node of the computing device. Examples of a state of collapsed identity graphs are shown in diagram 400A of FIG. 4A and diagram 500A of FIG. 5A.

In some embodiments, the identity resolution component determines that the identity nodes and edge(s) of the incoming customer interaction record causes the identity graph of the customer to collapse with a different identity graph associated with a different customer based on an identity namespace limit being exceeded by identity nodes of the collapsed identity graphs. An “identity namespace limit” generally refers to a constraint on the amount of unique identifiers (e.g., identity values) that can be associated with a particular identity graph for a particular identity namespace. For example, an identity namespace with an identity namespace limit of one indicates that an identity graph can only have one identity node (e.g., unique identity value) for the particular identity namespace (e.g., only 1 unique CRM ID can be associated with a given identity graph). In this regard, in some instances, the identity namespace limit can indicate which identity namespace is the person entity (e.g., the person entity of the customer is based on the CRM ID) as each customer requires a unique identity value for the particular identity namespace. Continuing with the example, if the identity graph has more than one identity node (e.g., more than one unique identity value) for the particular identity namespace with an identity namespace limit of one, the identity resolution component determines that a collapsed state of identity graphs has occurred and implements identity resolution in accordance with various embodiments of the present disclosure. In some embodiments, a user (e.g., on behalf of a business) configures the identity namespace limits for the identity namespaces. In some embodiments, only a portion of the identity namespaces are configured to include identity namespace limits. For example, a user may decide that a particular customer can be associated with an unlimited number of devices, email addresses, phone numbers, accounts for different brands of the business, and/or others. In this regard, when there is no identity namespace limit for a particular identity namespace, the identity graphs will not collapse based on the particular identity namespace. An example of identity namespace limits is shown at 402A of FIG. 4A.

The identity resolution component prunes (e.g., temporarily) edges of the collapsed state of the identity graphs resulting in a temporary state of the identity graphs. For example, in some embodiments, initially, only the identity nodes of the collapsed state of the identity graphs are present in the temporary state of the identity graphs (e.g., without edges connecting the identity nodes).

The identity resolution component re-applies each of the edges (e.g., pruned edges) to the temporary state of the identity graphs and determines whether the edge results in a non-collapsed state of the identity graphs (e.g., no identity namespace limits are exceeded). For example, if the re-application of the edge results in a non-collapsed state of the identity graphs, the edge is maintained in the temporary state until all edges are evaluated to determine a non-collapsed state of the identity graphs. However, if the re-application of the edge results in a collapsed state of the identity graphs (e.g., an identity namespace limit(s) is exceeded), the edge is pruned permanently from the temporary state and the resulting non-collapsed state.

In some embodiments, the identity resolution component determines edges of the collapsed state of the identity graphs that are incident (e.g., directly connected) to the identity nodes of the incoming customer interaction record and determines edges of the collapsed state of the identity graphs that are non-incident (e.g., not directly connected) to the identity nodes of the incoming customer interaction record. Continuing with the above example, the incident edges of the identity nodes associated with the incoming customer interaction record only include edges connected to the first node indicating the identity value and identity namespace of the device ID and edges connected to the second node indicating the identity value and identity namespace of the customer account ID. Any other edges of the collapsed state of the identity graphs are non-incident edges, such as an edge between identity node of the different customer account and an identity node of an email address (e.g., as the different customer account was not a part of the incoming customer interaction record). Examples of applying non-incident edges to a temporary state of the identity graphs is shown in diagram 400B of FIG. 4B and diagram 500B of FIG. 5B.

In some embodiments, the identity resolution component initially re-applies each of the edges (e.g., pruned edges) to the temporary state of the identity graphs that are non-incident to the identity nodes of the incoming customer interaction record (e.g., non-incident edges) to determine a non-collapsed state of the identity graphs. Subsequent to applying all of the non-incident edges to the temporary state of the identity graphs, the identity resolution component re-applies each of the edges to the temporary state of the identity graphs that are incident (e.g., directly connected) to the identity nodes of the incoming customer interaction record (e.g., incident edges) and determines whether each of the incident edges result in a non-collapsed state of the identity graphs in an order (e.g., based on properties of each incident edge). Applying the non-incident edges without a determination whether each of the non-incident edges result in a non-collapsed state of the identity graphs and only determining whether each of the incident edges result in a non-collapsed state of the identity graphs provides for a more efficient use of computing resources in certain scenarios (e.g., as the non-incident edges did not cause the identity graphs to collapse). Examples of applying non-incident edges to a temporary state of the identity graphs is shown in diagram 400B of FIG. 4B and subsequently applying the incident edges in a specific order is shown in diagrams 400C of FIG. 4C, diagram 400D of FIG. 4D, and diagram 400E of FIG. 4E.

The identity resolution component determines timestamp data and/or priority values of the edges (e.g., pruned edges) to determine the order to re-apply the edge(s) to the temporary state of the identity graphs to determine a non-collapsed state of the identity graphs. An example of using timestamp data and priority data to determine the order to re-apply the edge(s) is shown at 402B of FIG. 4B. The edge between two identity nodes provide timestamp data indicating when the most recent customer interaction event occurred between the two identity nodes (e.g., a last updated timestamp). Further, priority values of edges between two identity nodes can be determined based on priority values of each of the identity namespaces of the identity nodes (e.g., based on a summation of the priority values of the identity namespaces of the identity nodes). In some embodiments, a user (e.g., on behalf of a business) configures the priority values for the identity namespaces. An example of priority configurations is shown at 402A of FIG. 4A. In some embodiments, no two identity namespaces can be assigned a same priority value (e.g., all identity namespaces used by the business have different priority values). For example, different priority values can be assigned to different identity namespaces to prioritize more reliable identity namespaces (e.g., as determined by the business), such as customer IDs in certain scenarios, over less reliable identity namespaces (e.g., as determined by the business), such as email addresses in certain scenarios, to ensure that the identity resolution process utilizes the most reliable customer data (e.g., as determined by the business). In some embodiments, the identity resolution component only uses and/or determines timestamp data of the edges (e.g., pruned edges) to determine the order to re-apply the edge(s) to the temporary state of the identity graphs to determine a non-collapsed state of the identity graphs. In some embodiments, the identity resolution component only uses and/or determines priority values of the edges (e.g., pruned edges) to determine the order to re-apply the edge(s) to the temporary state of the identity graphs to determine a non-collapsed state of the identity graphs.

In some embodiments, the identity resolution component only uses and/or determines timestamp data and priority values of the incident edges in order to determine the order to re-apply the incident edge(s) to the temporary state of the identity graphs to determine a non-collapsed state of the identity graphs (e.g., as the non-incident edges are previously re- applied to the temporary state of the identity graphs to determine the non-collapsed state of the identity graphs). In some embodiments, the identity resolution component only uses and/or determines timestamp data of the incident edges in order to determine the order to re-apply the incident edge(s) to the temporary state of the identity graphs to determine a non-collapsed state of the identity graphs. In some embodiments, the identity resolution component only uses and/or determines priority values of the incident edges in order to determine the order to re-apply the incident edge(s) to the temporary state of the identity graphs to determine a non-collapsed state of the identity graphs.

In order to determine the order of the edge(s) (e.g., pruned edges) to re-apply to the temporary state of the identity graphs, the identity resolution component re-applies the edge(s) of the incoming customer interaction record. An example of re-applying the edge of the incoming customer interaction record is shown in diagram 400C of FIG. 4C. If by re-applying the edge(s) of the incoming customer interaction record, the identity graphs do not collapse to a collapsed state, the edge(s) of the incoming customer interaction record remain in the temporary state and the resulting non-collapsed state of the identity graphs. If by re-applying the edge(s) of the incoming customer interaction record, the identity graphs collapse to a collapsed state, the edge(s) of the incoming customer interaction record are permanently pruned from the temporary state and resulting collapsed state. Continuing with the example above, the edge between the first identity of the device ID and the second identity node of the customer account ID of the customer is re-applied (e.g., first after non-incident edges) to the temporary state of the identity graphs. In some embodiments, if the incoming customer interaction record includes identity nodes that exceed an identity namespace limit, the incoming customer interaction record is ignored (e.g., all of the identity nodes and edges of the incoming customer interaction record are not applied to the temporary state of the identity graphs and the resulting non-collapsed state of the identity graphs).

In some embodiments, the identity resolution component re-applies the edge(s) of the incoming customer interaction record after re-applying non-incident edges to the temporary state of the identity graphs to determine the non-collapsed state of the identity graphs. An example of re-applying the edge of the incoming customer interaction record after re-applying non-incident edges is shown in diagram 400C of FIG. 4C.

In some embodiments, the edge of the incoming customer interaction record is indicated as the edge with the most recent timestamp data. In this regard, the edge with the most recent timestamp data is re-applied first to the temporary state of the identity graphs (e.g., but after re-applying non-incident edges to the temporary state of the identity graphs in some embodiments). In some embodiments, when there is more than one edge of the incoming customer interaction record, the edges of the incoming customer interaction record are applied in order of priority value (e.g., starting with the edge of the incoming customer interaction record with highest priority value). In some embodiments, when there is more than one edge of the incoming customer interaction record, all of the edges of the incoming customer interaction record are applied simultaneously.

Subsequent to the identity resolution component re-applying the edge(s) (e.g., pruned edges) of the incoming customer interaction record to the temporary state to determine the non-collapsed state of the identity graphs, the remaining edges (e.g., pruned edges) are applied in order of priority value (e.g., starting with the remaining edge with highest priority value) to the temporary state to determine the non-collapsed state of the identity graphs. Examples of re-applying the remaining edges in order of priority value is shown in diagram 400D of FIG. 4D and diagram 400E of FIG. 4E (e.g., the priority values are shown in 402B of FIG. 4B). If by re-applying the remaining edge(s) to the temporary state, the identity graphs do not collapse to a collapsed state, the remaining edge(s) remain in the temporary state and resulting non-collapsed state of the identity graphs. If by re-applying the edge(s) to the temporary state, the identity graphs collapse to a collapsed state, the edge(s) are permanently pruned from the temporary state and resulting non-collapsed state. An example of permanently pruning a remaining edge that causes identity graphs collapse to a collapsed state is shown in diagram 400E of FIG. 4E. In some embodiments, if any remaining edge are equal in priority value, the remaining edges equal in priority value are applied in order of the timestamp data of the edges (e.g., starting with the remaining edge with most recent timestamp data).

After the identity resolution component re-applies each of the edges (e.g., pruned edges) to the temporary state of the identity graphs in order (e.g., based on properties of the edges) and permanently prunes any edges that result in a collapsed state of the identity graphs (e.g., an identity namespace limit(s) is exceeded), the identity resolution component determines a non-collapsed state of the identity graphs (e.g., no identity namespace limits are exceeded). Examples of a non-collapsed state of the identity graphs is shown in diagram 400F of FIG. 4F and diagram 500C of FIG. 5C. In this regard, the non-collapsed state of the identity graphs can be used to update a customer profile, such as by updating the customer profile of the customer to include data of the customer interaction record. Continuing with the above example, the customer profile of the customer is updated to include the device ID and data indicating the interaction of the customer logging in. Further, when the device ID is involved in a subsequent customer interaction the customer interaction data is associated with the customer in the customer profile (e.g., based on the customer's identity graph). An example of evaluating edges of collapsed identity graphs for identity resolution to update a customer profile of a customer is shown in diagram 300 of FIG. 3.

Advantageously, efficiencies of computing and network resources can be enhanced using implementations described herein. In particular, automatically evaluating edges (e.g., the time and priority of the edges) of the collapsed identity graphs to resolve the collapsed identity graphs provides for a more efficient use of computing resources (e.g., reduced computer input/output operations, higher throughput and reduced latency for a network, less packet generation costs, etc.) than manually applying the most up-to-date customer data for identity resolution of collapsed identity graphs and provides for more accurate results (e.g., due to human error, as no identity nodes are deleted from a customer's identity graph in some scenarios, etc.). In this regard, the technology described herein enables the automatic evaluation of the edges (e.g., the time and priority of the edges) of the collapsed identity graphs to resolve the collapsed identity graphs in an efficient and effective manner, thereby reducing unnecessary computing resources used to process the manual operations of manually accessing customer data to manually determine the most up-to-date customer data, manually accessing the customer data to manually determine the stale customer data that causes the identity graphs to collapse when the most up-to-date customer data is utilized, and manually deleting the stale customer data that causes the identity graphs to collapse thereby deleting identity nodes from the identity graphs. The technology described herein results in less input/output operations, less information over a computer network, which results in higher throughput, reduced latency, less packet generation costs as fewer packets are sent over a network, etc. Therefore, the technology described herein conserves computing and network resources.

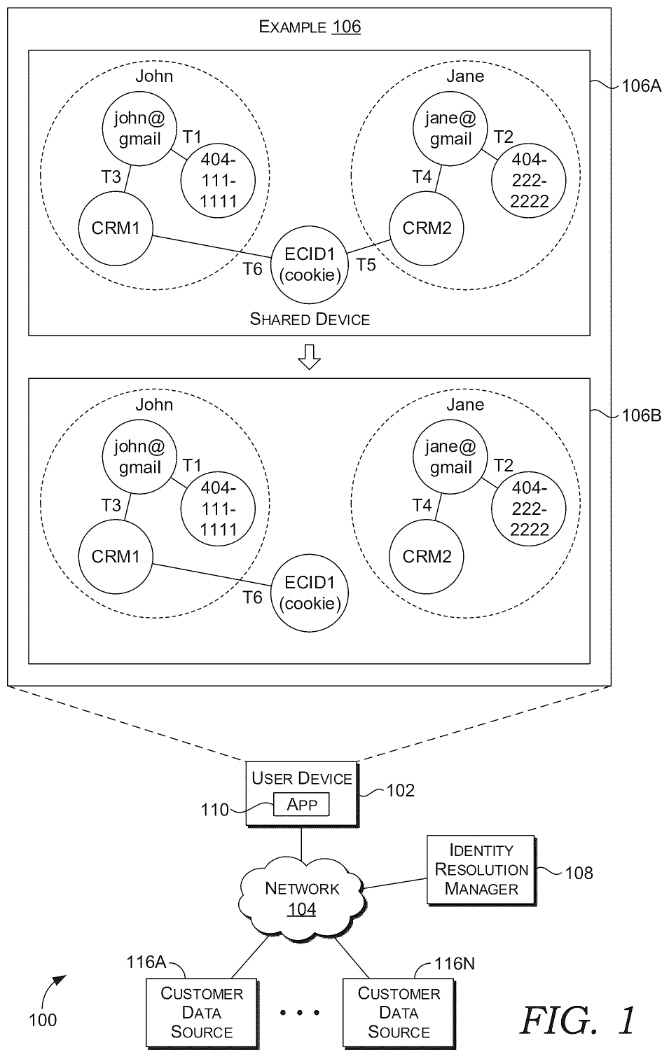

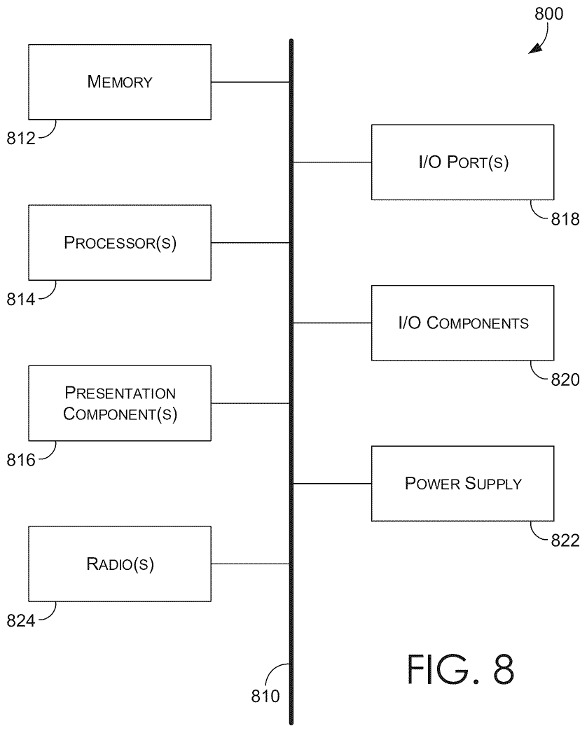

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 8.

It should be understood that operating environment 100 shown in FIG. 1 is an example of one suitable operating environment. Among other components not shown, operating environment 100 includes a user device 102, application 110, network 104, customer data sources 116A-N, and identity resolution manager 108. Operating environment 100 also shows an example 106 showing the evaluating of edges of collapsed identity graphs for identity resolution by automatically evaluating properties (e.g., time and priority) of the edges of the collapsed identity graphs to resolve the collapsed identity graphs. Example 106 includes an example 106A of a collapsed state of identity graphs where a device ID (e.g., ECID1) is associated with two customer accounts (e.g., CRM1 and CRM2). Example 106 includes an example 106B of a non-collapsed state of identity graphs after identity resolution where the device ID (e.g., ECID1) is only resolved associated with one customer accounts (e.g., CRM1) based on the most up-to-date customer data. Each of the components shown in FIG. 1 can be implemented via any type of computing device, such as one or more of computing device 800 described in connection to FIG. 8, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., a user implementing personalized and/or targeted marketing strategies on behalf of a business). For example, in some implementations, such devices are the type of computing device described in relation to FIG. 8. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

Application 110 operating on user device 102 can generally be any application capable of utilizing identity graphs and/or customer profiles, such as a customer experience management platform. In some implementations, the application 110 comprises a web application, which can run in a web browser, and could be hosted at least partially server-side (e.g., via identity resolution manager 108). In addition, or instead, the application 110 can comprise a dedicated application. In some cases, the application 110 is integrated into the operating system (e.g., as a service). Such an application may be accessed via a mobile application, a web application, or the like.

User device 102 can be a client device on a client-side of operating environment 100, while identity resolution manager 108 can be on a server-side of operating environment 100. Identity resolution manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or identity resolution manager 108 to remain as separate entities.

Application 110 operating on user device 102 can generally be any application capable of facilitating the exchange of information between the user device 102 and the identity resolution manager 108 in displaying and exchanging information regarding identity graphs and/or customer profiles. In some implementations, the application 110 comprises a web application, which can run in a web browser, and could be hosted at least partially on the server-side of environment 100. In addition, or instead, the application 110 can comprise a dedicated application. In some cases, the application 110 is integrated into the operating system (e.g., as a service). It is therefore contemplated herein that “application” be interpreted broadly.

In operation, the identity resolution manager 108 can obtain user data from user device 102, customer data from customer data sources 116a-116n, and any other data sources. Data sources 116a-116n may be any type of source providing data (e.g., customer data). Generally, the identity resolution manager 108 receives data from any number of devices. As such, the identity resolution manager 108 can identify and/or collect data from various user devices, such as user device 102, and sources, such as data sources 116a-116n. In this regard, the identity resolution manager 108 can retrieve or receive data collected or identified at various components, or sensors associated therewith.

As described, in some cases, the identity resolution manager 108 can retrieve or receive customer data from the user device 102 and customer data sources 116a-116n. Customer data within a dataset may include, by way of example and not limitation, data that is sensed or determined from one or more sensors, such as location information of mobile device(s), smartphone data (such as device ID, phone number, phone state, charging data, date/time, or other information derived from a smartphone), activity information (for example: email addresses, account ID, browser ID, app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, sports data, health data, and nearly any other source of data that may be used to identify the customer, as described herein.

Such customer data can be initially collected at remote locations or systems and transmitted to a data store for access by identity resolution manager 108. In accordance with embodiments described herein, customer collection may occur at data sources 116a-116n, respectively. In some cases, data sources 116a-116n, or portion thereof, may be client devices that is, computing devices operated by businesses or customers, respectively, for example. As such, client devices, or components associated therewith, can be used to collect various types of customer data. For example, in some embodiments, customer data may be obtained and collected at a client device operated by a customer via one or more sensors, which may be on or associated with one or more client devices and/or other computing devices. As used herein, a sensor may include a function, routine, component, or combination thereof for sensing, detecting, or otherwise obtaining information, such as customer data, and may be embodied as hardware, software, or both.

In addition or in the alternative to data sources 116a-116n including client devices, data sources 116a-116n may include servers, data stores, or other components that collect customer data, for example, from client devices associated with customers, websites, application, and/or the like. For example, in interacting with a client device, datasets may be captured at data sources 116a-116n and, thereafter, such customer data can be provided to identity resolution manager 108 for storage. Customer data may additionally or alternatively be obtained from an external server, for example, that collects customer data (e.g., data lake 308 of CRM records of FIG. 3). Customer data can be obtained at a data source periodically or in an ongoing manner (or at any time) and provided to the identity resolution manager 108 to facilitate updating identity graphs and/or customer profiles.

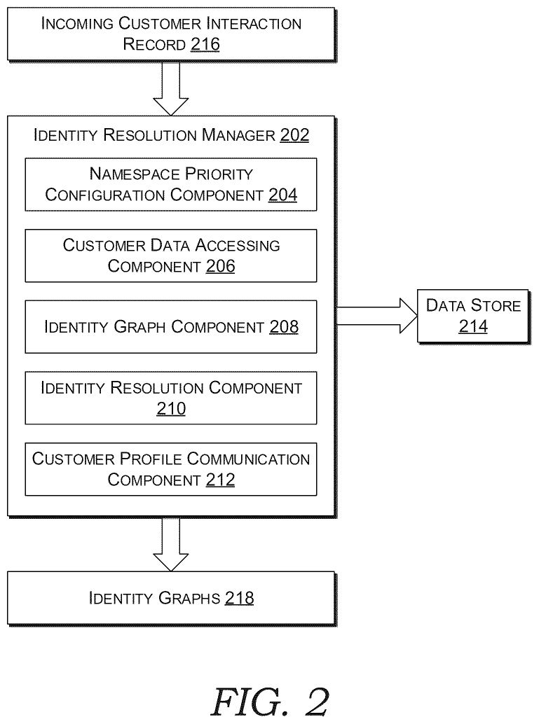

As described herein, identity resolution manager 108 can facilitate evaluating edges of collapsed identity graphs for identity resolution. Identity resolution manager 108 can be or include a server, including one or more processors, and one or more computer-readable media. The computer-readable media includes computer-readable instructions executable by the one or more processors. The instructions can optionally implement one or more components of identity resolution manager 108, described in additional detail below with respect to identity resolution manager 202 of FIG. 2.

At a high level, identity resolution manager 108 performs various functionality to facilitate evaluating edges of collapsed identity graphs for identity resolution, such as by automatically evaluating properties (e.g., time and priority) of the edges of the collapsed identity graphs to resolve the collapsed identity graphs in an efficient and effective manner so that an identity graph of a customer can be updated based on the most up-to-date customer data. In this regard, identity resolution manager 108 can access customer data, incoming records (e.g., customer interaction records), access identity graphs, update identity graphs, update customer profiles, etc. to application 110 of the user device. The identity graphs and/or customer profiles can be displayed via a display screen of the user device 102 and may be presented in any manner.

For cloud-based implementations, the instructions on identity resolution manager 108 can implement one or more components, and application 110 can be utilized by a user to interface with the functionality implemented on identity resolution manager 108. In some cases, application 110 comprises a web browser. In other cases, identity resolution manager 108 may not be required. For example, the components of identity resolution manager 108 may be implemented completely on a user device, such as user device 102. In this case, identity resolution manager 108 may be embodied at least partially by the instructions corresponding to application 110.

Thus, it should be appreciated that identity resolution manager 108 may be provided via multiple devices arranged in a distributed environment that collectively provide the functionality described herein. Additionally, other components not shown may also be included within the distributed environment. In addition, or instead, identity resolution manager 108 can be integrated, at least partially, into a user device, such as user device 102. Furthermore, identity resolution manager 108 may at least partially be embodied as a cloud computing service.

Referring to FIG. 2, aspects of an illustrative identity resolution management system are shown, in accordance with various embodiments of the present disclosure. At a high level, identity resolution management system can facilitate evaluating edges of collapsed identity graphs for identity resolution by automatically evaluating properties (e.g., time and priority) of the edges of the collapsed identity graphs to resolve the collapsed identity graphs.

As shown in FIG. 2, identity resolution manager 202 includes namespace priority configuration component 204, customer data accessing component 206, identity graph component 208, identity resolution component 210, and customer profile communication component 212. An incoming customer interaction record 216 is received by identity resolution manager 202 (e.g., through customer data sources 116A-N of FIG. 1). Identity resolution manager applies customer data of the incoming customer interaction record 216 to identity graphs 218 (e.g., where each identity graph of identity graphs 218 corresponds to a different customer). The identity resolution manager 202 facilitates evaluating edges of collapsed identity graphs for identity resolution by automatically evaluating properties (e.g., time and priority) of the edges of the collapsed identity graphs to resolve the collapsed identity graphs. The identity resolution manager 202 can communicate with the data store 214. The data store 214 is configured to store various types of information accessible by identity resolution manager 202, or other server or component. The foregoing components of identity resolution manager 202 can be implemented, for example, in operating environment 100 of FIG. 1. In particular, those components may be integrated into any suitable combination of user devices 102 and/or identity resolution manager 108.

In embodiments, data sources, such as customer data sources (e.g., 116A-116N of FIG. 1), user devices (such as user device 102 of FIG. 1), and identity resolution manager 202 can provide data to the data store 214 for storage, which may be retrieved or referenced by any such component. As such, the data store 214 can store computer instructions (e.g., software program instructions, routines, or services), data and/or models used in embodiments described herein. In some implementations, data store 214 can store information or data received or generated via the various components of identity resolution manager 202 and provides the various components with access to that information or data, as needed. The information in data store 214 may be distributed in any suitable manner across one or more data stores for storage (which may be hosted externally).

The namespace priority configuration component 204 is generally configured to allow a user to configure the priority values for identity namespaces. In embodiments, namespace priority configuration component 204 can include rules, conditions, associations, models, algorithms, or the like to allow a user to configure the priority values for identity namespaces. The customer data accessing component 206 is generally configured to access customer data, such as incoming customer interaction records. In embodiments, customer data accessing component 206 can include rules, conditions, associations, models, algorithms, or the like to access customer data, such as incoming customer interaction records. The customer profile communication component 212 is generally configured to update a customer profile based on customer data from an identity graph. In embodiments, customer profile communication component 212 can include rules, conditions, associations, models, algorithms, or the like to update a customer profile based on customer data from an identity graph.

The identity graph component 208 is generally configured to apply identity nodes and edges based on customer data, such as incoming customer interaction records, to identity graphs. In embodiments, identity graph component 208 can include rules, conditions, associations, models, algorithms, or the like to apply identity nodes and edges to identity graphs. For example, identity graph component 208 may comprise a statistical model, fuzzy logic, neural network, finite state machine, support vector machine, logistic regression, clustering, or machine-learning techniques, similar statistical classification processes, or combinations of to apply identity nodes and edges based on customer data, such as incoming customer interaction records, to identity graphs.

The identity resolution component 210 is generally configured to evaluate collapsed identity graphs for identity resolution. In embodiments, identity resolution component 210 can include rules, conditions, associations, models, algorithms, or the like to evaluate collapsed identity graphs for identity resolution. For example, identity resolution component 210 may comprise a statistical model, fuzzy logic, neural network, finite state machine, support vector machine, logistic regression, clustering, or machine-learning techniques, similar statistical classification processes, or combinations of to evaluate collapsed identity graphs for identity resolution.

In embodiments, an incoming customer interaction record 216 is accessed by customer data accessing component 206. The customer interaction record 216 includes data regarding the customer interaction event, such as the identity value and identity namespace of the identities (e.g., the device ID and the customer account ID), timestamp data indicating when the customer interaction event occurred, and/or any other customer data regarding the interaction (e.g., logging into the account, browsing or performing an action). In some embodiments, the data regarding the customer interaction record is collected by a data collection component (e.g., 310 of FIG. 3) in communication with customer data accessing component 206. In some embodiments, the data regarding the incoming record is stored in data store 214 and accessed by customer data accessing component 206.

The identity graph component 208 applies identity nodes and edge(s) of the incoming customer interaction record 216 to an identity graph associated with the customer from identity graphs 218. Identity resolution component 210 determines that the identity nodes and edge(s) of the incoming customer interaction record 216 causes the identity graph of the customer to collapse with a different identity graph associated with a different customer resulting in a collapsed state of the identity graphs (e.g. identity graphs 218). Examples of a state of collapsed identity graphs are shown in diagram 400A of FIG. 4A and diagram 500A of FIG. 5A. In some embodiments, identity resolution component 210 determines that the identity nodes and edge(s) of the incoming customer interaction record 216 causes the identity graph of the customer to collapse with a different identity graph associated with a different customer based on an identity namespace limit being exceeded by identity nodes of the collapsed identity graphs.

In some embodiments, a user (e.g., on behalf of a business) configures the identity namespace limits for the identity namespaces using namespace priority configuration component 204. In some embodiments, only a portion of the identity namespaces are configured to include identity namespace limits using namespace priority configuration component 204. In this regard, in some embodiments, when there is no identity namespace limit for a particular identity namespace, the identity graphs will not collapse based on the particular identity namespace. An example of identity namespace limits is shown at 402A of FIG. 4A.

Identity resolution component 210 prunes (e.g., temporarily) edges of the collapsed state of the identity graphs resulting in a temporary state of the identity graphs. For example, in some embodiments, initially, only the identity nodes of the collapsed state of the identity graphs are present in the temporary state of the identity graphs (e.g., without edges connecting the identity nodes).

The identity resolution component 210 re-applies each of the edges (e.g., pruned edges) to the temporary state of the identity graphs and determines whether the edge results in a non-collapsed state of the identity graphs. For example, if the re-application of the edge results in a non-collapsed state of the identity graphs (e.g., no identity namespace limits are exceeded), the edge is maintained in the temporary state until all edges are evaluated to determine a non-collapsed state of the identity graphs. However, if the re-application of the edge results in a collapsed state of the identity graphs (e.g., an identity namespace limit(s) is exceeded), the edge is pruned permanently from the temporary state and the resulting non-collapsed state.

In some embodiments, the identity resolution component 210 determines edges of the collapsed state of the identity graphs that are incident (e.g., directly connected) to the identity nodes of the incoming customer interaction record and determines edges of the collapsed state of the identity graphs that are non-incident (e.g., not directly connected) to the identity nodes of the incoming customer interaction record. In some embodiments, the identity resolution component 210 initially re-applies each of the edges (e.g., pruned edges) to the temporary state of the identity graphs that are non-incident to the identity nodes of the incoming customer interaction record (e.g., non-incident edges) to determine a non-collapsed state of the identity graphs. Subsequent to applying all of the non-incident edges to the temporary state of the identity graphs, the identity resolution component 210 re-applies each of the edges to the temporary state of the identity graphs that are incident (e.g., directly connected) to the identity nodes of the incoming customer interaction record (e.g., incident edges) and determines whether each of the incident edges result in a non-collapsed state of the identity graphs in an order (e.g., based on properties of each incident edge). Examples of applying non-incident edges to a temporary state of the identity graphs is shown in diagram 400B of FIG. 4B and subsequently applying the incident edges in a specific order is shown in diagrams 400C of FIG. 4C, diagram 400D of FIG. 4D, and diagram 400E of FIG. 4E.

The identity resolution component 210 determines timestamp data and/or priority values of the edges (e.g., pruned edges) to determine the order to re-apply the edge(s) to the temporary state of the identity graphs to determine a non-collapsed state of the identity graphs. An example of using timestamp data and priority data to determine the order to re-apply the edge(s) is shown at 402B of FIG. 4B. The edge between two identity nodes provide timestamp data indicating when the most recent customer interaction event occurred between the two identity nodes (e.g., a last updated timestamp). Further, priority values of edges between two identity nodes can be determined based on priority values of each of the identity namespaces of the identity nodes (e.g., based on a summation of the priority values of the identity namespaces of the identity nodes). In some embodiments, the identity resolution component 210 only uses and/or determines timestamp data of the edges (e.g., pruned edges) to determine the order to re-apply the edge(s) to the temporary state of the identity graphs to determine a non-collapsed state of the identity graphs. In some embodiments, the identity resolution component 210 only uses and/or determines priority values of the edges (e.g., pruned edges) to determine the order to re-apply the edge(s) to the temporary state of the identity graphs to determine a non-collapsed state of the identity graphs.

In some embodiments, a user (e.g., on behalf of a business) configures the priority values for the identity namespaces using namespace priority configuration component 204. An example of priority configurations is shown at 402A of FIG. 4A. In some embodiments, no two identity namespaces can be assigned a same priority value (e.g., all identity namespaces used by the business have different priority values).

In some embodiments, the identity resolution component 210 only uses and/or determines timestamp data and priority values of the incident edges in order to determine the order to re-apply the incident edge(s) to the temporary state of the identity graphs to determine a non-collapsed state of the identity graphs (e.g., as the non-incident edges are previously re-applied to the temporary state of the identity graphs to determine the non-collapsed state of the identity graphs). In some embodiments, the identity resolution component 210 only uses and/or determines timestamp data of the incident edges in order to determine the order to re-apply the incident edge(s) to the temporary state of the identity graphs to determine a non-collapsed state of the identity graphs. In some embodiments, the identity resolution component 210 only uses and/or determines priority values of the incident edges in order to determine the order to re-apply the incident edge(s) to the temporary state of the identity graphs to determine a non-collapsed state of the identity graphs.

In order to determine the order of the edge(s) (e.g., pruned edges) to re-apply to the temporary state of the identity graphs, the identity resolution component 210 re-applies the edge(s) of the incoming customer interaction record. An example of re-applying the edge of the incoming customer interaction record is shown in diagram 400C of FIG. 4C. If by re-applying the edge(s) of the incoming customer interaction record, the identity graphs do not collapse to a collapsed state, the edge(s) of the incoming customer interaction record remain in the temporary state and the resulting non-collapsed state of the identity graphs. If by re-applying the edge(s) of the incoming customer interaction record, the identity graphs collapse to a collapsed state, the edge(s) of the incoming customer interaction record are permanently pruned from the temporary state and resulting collapsed state. In some embodiments, if the incoming customer interaction record includes identity nodes that exceed an identity namespace limit, the incoming customer interaction record is ignored (e.g., all of the identity nodes and edges of the incoming customer interaction record are not applied to the temporary state of the identity graphs and the resulting non-collapsed state of the identity graphs).

In some embodiments, the identity resolution component 210 re-applies the edge(s) of the incoming customer interaction record after re-applying non-incident edges to the temporary state of the identity graphs to determine the non-collapsed state of the identity graphs. An example of re-applying the edge of the incoming customer interaction record after re-applying non-incident edges is shown in diagram 400C of FIG. 4C. In some embodiments, the edge of the incoming customer interaction record is indicated as the edge with the most recent timestamp data. In this regard, the edge with the most recent timestamp data is re-applied first to the temporary state of the identity graphs (e.g., but after re-applying non-incident edges to the temporary state of the identity graphs in some embodiments). In some embodiments, when there is more than one edge of the incoming customer interaction record, the edges of the incoming customer interaction record are applied in order of priority value (e.g., starting with the edge of the incoming customer interaction record with highest priority value). In some embodiments, when there is more than one edge of the incoming customer interaction record, all of the edges of the incoming customer interaction record are applied simultaneously.

Subsequent to the identity resolution component 210 re-applying the edge(s) (e.g., pruned edges) of the incoming customer interaction record to the temporary state to determine the non-collapsed state of the identity graphs, the remaining edges (e.g., pruned edges) are applied in order of priority value (e.g., starting with the remaining edge with highest priority value) to the temporary state to determine the non-collapsed state of the identity graphs. Examples of re-applying the remaining edges in order of priority value is shown in diagram 400D of FIG. 4D and diagram 400E of FIG. 4E (e.g., the priority values are shown in 402B of FIG. 4B). If by re-applying the remaining edge(s) to the temporary state, the identity graphs do not collapse to a collapsed state, the remaining edge(s) remain in the temporary state and resulting non-collapsed state of the identity graphs. If by re-applying the edge(s) to the temporary state, the identity graphs collapse to a collapsed state, the edge(s) are permanently pruned from the temporary state and resulting non-collapsed state. An example of permanently pruning a remaining edge that causes identity graphs collapse to a collapsed state is shown in diagram 400E of FIG. 4E. In some embodiments, if any remaining edge are equal in priority value, the remaining edges equal in priority value are applied in order of the timestamp data of the edges (e.g., starting with the remaining edge with most recent timestamp data).

After the identity resolution component 210 re-applies each of the edges (e.g., pruned edges) to the temporary state of the identity graphs in order (e.g., based on properties of the edges) and permanently prunes any edges that result in a collapsed state of the identity graphs (e.g., an identity namespace limit(s) is exceeded), the identity resolution component 210 determines a non-collapsed state of the identity graphs (e.g., no identity namespace limits are exceeded). Examples of a non-collapsed state of the identity graphs is shown in diagram 400F of FIG. 4F and diagram 500C of FIG. 5C. In this regard, the non-collapsed state of the identity graphs 218 can be used to update a customer profile, such as by updating the customer profile of the customer to include data of the customer interaction record (e.g., and/or subsequent customer interactions that utilize a corresponding identity node of the customer interaction record) via customer profile communication component 212. An example of evaluating edges of collapsed identity graphs for identity resolution to update a customer profile of a customer is shown in diagram 300 of FIG. 3.

FIG. 3 provides an example diagram for evaluating edges of collapsed identity graphs for identity resolution, in accordance with embodiments of the present disclosure. As can be understood, a user inputs priority values and identity namespace limits of namespaces. Configuration 302 provides an indication of the priority values of the namespaces and whether the values must be unique (e.g., an identity namespace limit of 1) in an identity graph. As can be understood, the device ID (ECID) is not unique and causes the identity graphs of two customers, Alice and Bob, to collapse. The user behavior 304 shows examples of how customer data is collected. CRM records can be ingested into data lake 308. Customer data can also be collected by data collection component 310. System behavior 306 shows examples of how the identity service 312 (e.g., identity resolution manager 202 of FIG. 2) resolves identity graphs of customers in order to update customer profiles through profile service 312 (e.g., via customer profile communication component 212). For example, identity service 312 handles the management of identity graphs and profile service 314 manages customer profile, for example, to optimize personalized and/or targeted marketing strategies based on the customer profile.

FIGS. 4A-4D provide an example of evaluating edges of collapsed identity graphs for identity resolution, in accordance with embodiments of the present disclosure. As can be understood, diagram 400A of FIG. 4A shows an example of collapsed identity graphs (e.g., an identity namespace limit(s) is exceeded) based on an incoming customer interaction record where customer account CRM1 is accessed on user device ECID1 at time t6. Configuration 402A shows priority values of identity namespaces and identity namespace limits for the number of identity values for the identity namespaces for a single customer (e.g., identity graph of the customer). Diagram 400B of FIG. 4B shows an example of the applying the edges that are non-incident to the identity nodes and edges of the incoming customer interaction record (e.g., edges t3, t5, and t6 are the edges that are incident to the identity nodes and edges of the incoming customer interaction record-CRM 1 and ECID1). Order determination 402B shows the use of the edge of the incoming record and identity values of configuration 402A of FIG. 4A to determine the order of re-applying the edges that are incident to the identity nodes and edges of the incoming customer interaction record. Diagram 400C of FIG. 4C shows that edge t6 does not cause a collapsed state of the graph (e.g., no identity namespace limits are exceeded), so it is applied to the temporary state of the identity graphs to determine the non-collapsed state of the identity graphs. Diagram 400D of FIG. 4D shows that edge t3 does not cause a collapsed state of the graph (e.g., no identity namespace limits are exceeded), so it is applied to the temporary state of the identity graphs to determine the non-collapsed state of the identity graphs. Diagram 400E of FIG. 4E shows that edge t5 causes a collapsed state of the graph (e.g., an identity namespace limit(s) is exceeded), so edge t5 is permanently pruned from the temporary state of the identity graphs and the non-collapsed state of the identity graphs. Diagram 400F of FIG. 4F shows the non-collapsed state of the identity graphs (e.g., as determined by identity resolution manager 202 of FIG. 2, identity service 312 of FIG. 3, etc.).

FIGS. 5A-5C provides another example of evaluating edges of collapsed identity graphs for identity resolution, in accordance with embodiments of the present disclosure. As can be understood, diagram 500A of FIG. 5A shows an example of collapsed identity graphs 502A and 502B (e.g., an identity namespace limit(s) is exceeded) based on an incoming customer interaction record where customer account 2 is accessed on user device ECID1 via browser ID 1 at time t=6. Diagram 500B of FIG. 5B shows an example of the applying the edges that are non-incident to the identity nodes and edges of the incoming customer interaction record (e.g., edges t=6, t=5, and t=4 are the edges that are incident to the identity nodes and edges of the incoming customer interaction record—Account 2, Browser 1, and ECID1). Diagram 500C of FIG. 5C shows the non-collapsed state of the identity graphs where no identity namespace limits are exceeded (e.g., as determined by identity resolution manager 202 of FIG. 2, identity service 312 of FIG. 3, etc.).

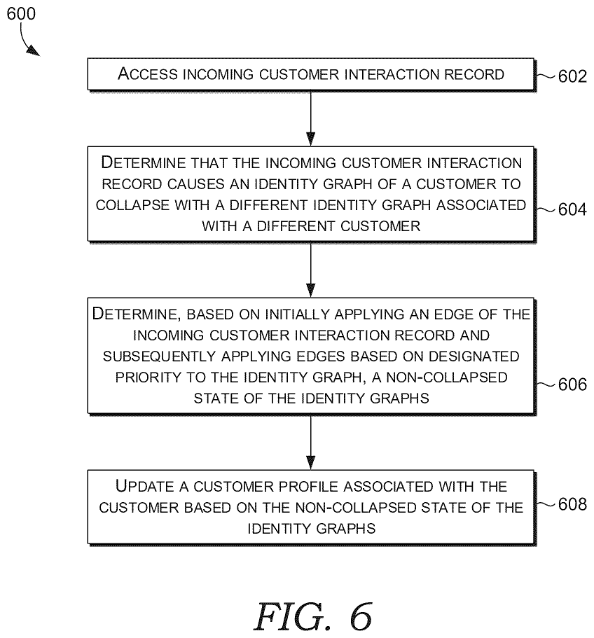

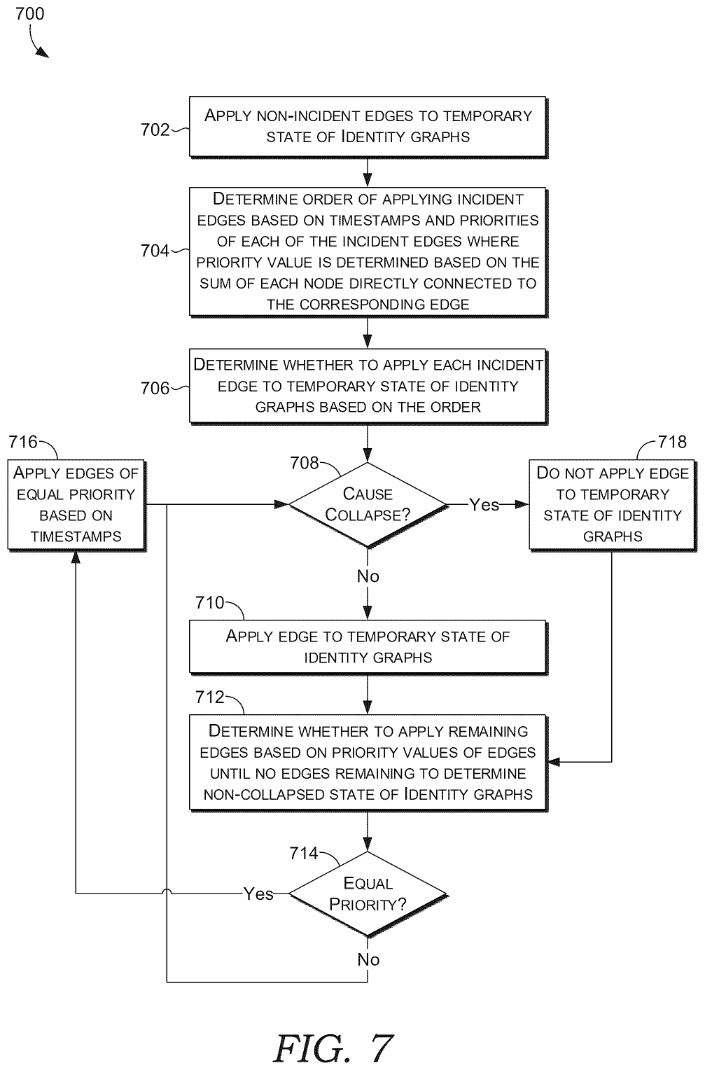

With reference now to FIGS. 6-7, FIGS. 6-7 provide method flows related to facilitating evaluating edges of collapsed identity graphs for identity resolution, in accordance with embodiments of the present technology. Each block of method 600 and 700 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 6-7 are exemplary only and not intended to be limiting. As can be appreciated, in some embodiments, method flows 600-700 can be implemented, at least in part, to facilitate evaluating edges of collapsed identity graphs for identity resolution.

Turning now to FIG. 6, a flow diagram 600 is provided showing an embodiment of a method 600 for evaluating edges of collapsed identity graphs for identity resolution, in accordance with embodiments described herein. Initially, at block 602, an incoming customer interaction record, such as a customer interaction record with customer data, is accessed. For example, the customer interaction record includes data regarding the customer interaction event, such as the identity value and identity namespace of the identities (e.g., the device ID and the customer account ID), timestamp data indicating when the customer interaction event occurred, and/or any other customer data regarding the interaction (e.g., logging into the account, browsing or performing an action). In some embodiments, the data regarding the customer interaction record is collected by a data collection component in communication with an identity graph component. In some embodiments, the data regarding the incoming record is stored in data store (e.g., from a customer relationship management (CRM) system) and accessed by the identity graph component.

At block 604, it is determined that the incoming customer interaction record causes an identity graph of a customer to collapse with a different identity graph associated with a different customer. For example, an identity graph component applies identity nodes and edge(s) of the incoming customer interaction record to an identity graph associated with the customer. An identity resolution component determines that the identity nodes and edge(s) of the incoming customer interaction record causes the identity graph of the customer to collapse with a different identity graph associated with a different customer resulting in a collapsed state of the identity graphs. In some embodiments, the identity resolution component determines that the identity nodes and edge(s) of the incoming customer interaction record causes the identity graph of the customer to collapse with a different identity graph associated with a different customer based on an identity namespace limit being exceeded by identity nodes of the collapsed identity graphs. An example of identity namespace limits is shown at 402A of FIG. 4A.

At block 606, a non-collapsed state of the identity graphs (e.g., no identity namespace limits are exceeded) is determined based on initially applying an edge of the incoming customer interaction record and subsequently applying edges based on designated priority to the identity graph. For example, the identity resolution component prunes (e.g., temporarily) edges of the collapsed state of the identity graphs resulting in a temporary state of the identity graphs. For example, in some embodiments, initially, only the identity nodes of the collapsed state of the identity graphs are present in the temporary state of the identity graphs (e.g., without edges connecting the identity nodes). The identity resolution component re-applies each of the edges (e.g., pruned edges) to the temporary state of the identity graphs and determines whether the edge results in a non-collapsed state of the identity graphs. For example, if the re-application of the edge results in a non-collapsed state of the identity graphs, the edge is maintained in the temporary state until all edges are evaluated to determine a non-collapsed state of the identity graphs. However, if the re-application of the edge results in a collapsed state of the identity graphs (e.g., an identity namespace limit(s) is exceeded), the edge is pruned permanently from the temporary state and the resulting non-collapsed state.

In some embodiments, the identity resolution component determines edges of the collapsed state of the identity graphs that are incident (e.g., directly connected) to the identity nodes of the incoming customer interaction record and determines edges of the collapsed state of the identity graphs that are non-incident (e.g., not directly connected) to the identity nodes of the incoming customer interaction record. In some embodiments, the identity resolution component initially re-applies each of the edges (e.g., pruned edges) to the temporary state of the identity graphs that are non-incident to the identity nodes of the incoming customer interaction record (e.g., non-incident edges) to determine a non-collapsed state of the identity graphs. Subsequent to applying all of the non-incident edges to the temporary state of the identity graphs, the identity resolution component re-applies each of the edges to the temporary state of the identity graphs that are incident (e.g., directly connected) to the identity nodes of the incoming customer interaction record (e.g., incident edges) and determines whether each of the incident edges result in a non-collapsed state of the identity graphs in an order (e.g., based on properties of each incident edge).

The identity resolution component determines timestamp data and/or priority values of the edges (e.g., pruned edges) to determine the order to re-apply the edge(s) to the temporary state of the identity graphs to determine a non-collapsed state of the identity graphs. The edge between two identity nodes provide timestamp data indicating when the most recent customer interaction event occurred between the two identity nodes (e.g., a last updated timestamp). Further, priority values of edges between two identity nodes can be determined based on priority values of each of the identity namespaces of the identity nodes (e.g., based on a summation of the priority values of the identity namespaces of the identity nodes). In some embodiments, the identity resolution component only uses and/or determines timestamp data of the edges (e.g., pruned edges) to determine the order to re-apply the edge(s) to the temporary state of the identity graphs to determine a non-collapsed state of the identity graphs. In some embodiments, the identity resolution component only uses and/or determines priority values of the edges (e.g., pruned edges) to determine the order to re-apply the edge(s) to the temporary state of the identity graphs to determine a non-collapsed state of the identity graphs.

In some embodiments, the identity resolution component only uses and/or determines timestamp data and priority values of the incident edges in order to determine the order to re-apply the incident edge(s) to the temporary state of the identity graphs to determine a non-collapsed state of the identity graphs (e.g., as the non-incident edges are previously re-applied to the temporary state of the identity graphs to determine the non-collapsed state of the identity graphs). In some embodiments, the identity resolution component only uses and/or determines timestamp data of the incident edges in order to determine the order to re-apply the incident edge(s) to the temporary state of the identity graphs to determine a non-collapsed state of the identity graphs. In some embodiments, the identity resolution component only uses and/or determines priority values of the incident edges in order to determine the order to re-apply the incident edge(s) to the temporary state of the identity graphs to determine a non-collapsed state of the identity graphs.

In order to determine the order of the edge(s) (e.g., pruned edges) to re-apply to the temporary state of the identity graphs, the identity resolution component re-applies the edge(s) of the incoming customer interaction record. If by re-applying the edge(s) of the incoming customer interaction record, the identity graphs do not collapse to a collapsed state (e.g., no identity namespace limits are exceeded), the edge(s) of the incoming customer interaction record remain in the temporary state and the resulting non-collapsed state of the identity graphs. If by re-applying the edge(s) of the incoming customer interaction record, the identity graphs collapse to a collapsed state (e.g., an identity namespace limit(s) is exceeded), the edge(s) of the incoming customer interaction record are permanently pruned from the temporary state and resulting non-collapsed state. In some embodiments, if the incoming customer interaction record includes identity nodes that exceed an identity namespace limit, the incoming customer interaction record is ignored (e.g., all of the identity nodes and edges of the incoming customer interaction record are not applied to the temporary state of the identity graphs and the resulting non-collapsed state of the identity graphs).

In some embodiments, the identity resolution component re-applies the edge(s) of the incoming customer interaction record after re-applying non-incident edges to the temporary state of the identity graphs to determine the non-collapsed state of the identity graphs.

In some embodiments, the edge of the incoming customer interaction record is indicated as the edge with the most recent timestamp data. In this regard, the edge with the most recent timestamp data is re-applied first to the temporary state of the identity graphs (e.g., but after re-applying non-incident edges to the temporary state of the identity graphs in some embodiments). In some embodiments, when there is more than one edge of the incoming customer interaction record, the edges of the incoming customer interaction record are applied in order of priority value (e.g., starting with the edge of the incoming customer interaction record with highest priority value). In some embodiments, when there is more than one edge of the incoming customer interaction record, all of the edges of the incoming customer interaction record are applied simultaneously.

Subsequent to the identity resolution component re-applying the edge(s) (e.g., pruned edges) of the incoming customer interaction record to the temporary state to determine the non-collapsed state of the identity graphs, the remaining edges (e.g., pruned edges) are applied in order of priority value (e.g., starting with the remaining edge with highest priority value) to the temporary state to determine the non-collapsed state of the identity graphs. If by re-applying the remaining edge(s) to the temporary state, the identity graphs do not collapse to a collapsed state, the remaining edge(s) remain in the temporary state and resulting non-collapsed state of the identity graphs. If by re-applying the edge(s) to the temporary state, the identity graphs collapse to a collapsed state, the edge(s) are permanently pruned from the temporary state and resulting non-collapsed state. In some embodiments, if any remaining edge are equal in priority value, the remaining edges equal in priority value are applied in order of the timestamp data of the edges (e.g., starting with the remaining edge with most recent timestamp data).

After the identity resolution component re-applies each of the edges (e.g., pruned edges) to the temporary state of the identity graphs in order (e.g., based on properties of the edges) and permanently prunes any edges that result in a collapsed state of the identity graphs (e.g., an identity namespace limit(s) is exceeded), the identity resolution component determines a non-collapsed state of the identity graphs (e.g., no identity namespace limits are exceeded).

At block 608, a profile associated with the customer is updated based on the non-collapsed state of the identity graphs. For example, the non-collapsed state of the identity graphs can be used to update a customer profile, such as by updating the customer profile of the customer to include data of the customer interaction record (e.g., and/or subsequent customer interactions that utilize a corresponding identity node of the customer interaction record).

Turning now to FIG. 7, a flow diagram 700 is provided showing an embodiment of a method 700 for evaluating edges of collapsed identity graphs for identity resolution, in accordance with embodiments described herein. Initially, at block 702, non-incident edges are applied to a temporary state of identity graphs. For example, it is determined that an incoming customer interaction record causes an identity graph of a customer to collapse with a different identity graph associated with a different customer (e.g., an identity namespace limit(s) is exceeded) and the edges of the collapsed state of the identity graphs are pruned temporarily (e.g., as a temporary state of the identity graphs).

At block 704, the order of applying incident edges is determined based on timestamps and priority values of each of the incident edges, where the priority values are determined based on each priority value of each node directly connected to the corresponding edge. For example, priority values of edges between two identity nodes can be determined based on priority values of each of the identity namespaces of the identity nodes (e.g., based on a summation of the priority values of the identity namespaces of the individual identity nodes). In this regard, the order of incident edges can be applied using timestamps and priority values of the edges. First, the edges of the incoming customer interaction record are applied (e.g., the edges that include the most recent timestamp). After the edges of the incoming customer interaction record are applied, the remaining incident edges are applied in order of priority (e.g., and timestamps for edges that have equal priority values).

At block 706, it is determined whether to apply each edge to the temporary state of identity graphs based on the order determined in block 704. In some embodiments, if the incoming customer interaction record includes identity nodes that exceed an identity namespace limit, the incoming customer interaction record is ignored. For example, if an identity namespace limit for an email address is defined as one email (e.g., Email namespace=1), but the incoming customer interaction record includes two emails (e.g., the incoming record includes an identity node of Email:email1@email.com and an identity node of Email:email2@email.com), the incoming customer interaction record (e.g., including all of the identity nodes and edges of the incoming customer interaction record) is not applied to the temporary state of the identity graphs and the resulting non-collapsed state of the identity graphs.

At block 708, for the edges of the incoming customer interaction record, it is determined if the edge of the incoming customer interaction record causes a collapsed state of the identity graphs. If a collapsed state is caused, at block 718, the edge is not applied to the temporary state of the identity graphs. If the temporary state results in a non-collapsed state, at block 710, the edge is applied to the temporary state of the identity graphs.

At block 712, subsequent to applying the edge of the incoming customer interaction record, it is determined whether to apply each remaining edge (e.g., each remaining incident edge) in order of the priority values of the edges until there are no edges remaining and the identity graphs results in a non-collapsed state of the identity graphs. At block 714, it is determined whether priority values of remaining edges have equal priority values. If not, at block 708, it is determined if the edge of the incoming customer interaction record causes a collapsed state of the identity graphs. If a collapsed state is caused, at block 718, the edge is not applied to the temporary state of the identity graphs. If the temporary state results in a non-collapsed state, at block 710, the edge is applied to the temporary state of the identity graphs.

If it is determined that remaining edges have equal priority values at block 714, at block 716, the edges are applied in order of the timestamps (e.g., based on each last updated timestamp). At block 708, it is determined if the edge of the incoming customer interaction record causes a collapsed state of the identity graphs. If a collapsed state is caused, at block 718, the edge is not applied to the temporary state of the identity graphs. If the temporary state results in a non-collapsed state, at block 710, the edge is applied to the temporary state of the identity graphs.

At block 712, the process is repeated until there are no edges remaining and the identity graphs results in a non-collapsed state of the identity graphs (e.g., no identity namespace limits are exceeded). In this regard, the non-collapsed state of the identity graphs can be used to update a customer profile, such as by updating the customer profile of the customer to include data of the customer interaction record (e.g., and/or subsequent customer interactions that utilize a corresponding identity node of the customer interaction record).

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 8 in particular, an exemplary operating environment for implementing aspects of the technology described herein is shown and designated generally as computing device 800. Computing device 800 is just one example of a suitable computing environment and is not intended to suggest any limitation as to the scope of use or functionality of the technology described herein. Neither should the computing device 800 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, an illustrative power supply 822, and a radio(s) 824. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 8 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Exemplary memory includes solid-state memory, hard drives, and optical-disc drives. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, and vibrating component. I/O port(s) 818 allow computing device 800 to be logically coupled to other devices including I/O components 820, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 800. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include radio(s) 824. The radio 824 transmits and receives radio communications. The computing device may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

What is claimed is:

1. A computer-implemented method comprising:
determining, based on applying an identity node and an edge associated with an incoming record to a plurality of identity graphs, a collapsed state of the plurality of identity graphs, each identity graph of the plurality of identity graphs corresponding to a data structure mapping relationships between identities;
determining, based on pruning a plurality of edges of the collapsed state, a temporary state of the plurality of identity graphs;
determining, based on applying the edge associated with the incoming record to the temporary state, a non-collapsed state of the plurality of identity graphs comprising the edge;
determining, based on applying a different edge of the plurality of edges to the temporary state comprising the edge and resulting in the collapsed state, to prune the different edge from the non-collapsed state; and
causing updating of a corresponding identity graph based on the non-collapsed state of the plurality of identity graphs.

2. The computer-implemented method of claim 1, further comprising:
subsequent to applying a non-incident edge to the temporary state that is non-incident to the identity node associated with the incoming record, applying the edge associated with the incoming record to the temporary state comprising the non-incident edge.

3. The computer-implemented method of claim 1, further comprising:
determining to apply the different edge to the temporary state before a subsequent different edge based on a corresponding priority value that is less than the priority value of the different edge.

4. The computer-implemented method of claim 1, further comprising:
determining to apply the different edge to the temporary state before a subsequent different edge based on a corresponding priority value that is equal to the priority value of the different edge and a corresponding timestamp that is less recent than a timestamp of the different edge.

5. The computer-implemented method of claim 1, further comprising:
determining a priority value of the different edge based on each corresponding priority value of each corresponding identity node connected by the different edge.

6. The computer-implemented method of claim 1, further comprising:
determining the collapsed state based on an identity namespace limit above a limit; and
determining the non-collapsed state based on the identity namespace limit within the limit.

7. The computer-implemented method of claim 1, further comprising:
accessing the incoming record, the incoming record comprising customer data corresponding to an identity value and an identity namespace of the identity node, timestamp data corresponding to the edge, and interaction data; and
further causing updating of a customer profile associated with the corresponding identity graph based on the interaction data.

8. One or more computer-readable media having a plurality of executable instructions embodied thereon, which, when executed by one or more processors, cause the one or more processors to perform a method comprising:
determining, based on applying an identity node and an edge associated with a record to a plurality of identity graphs, a collapsed state of the plurality of identity graphs, each identity graph of the plurality of identity graphs corresponding to a data structure mapping relationships between identities;
determining, based on pruning a plurality of edges of the collapsed state, a temporary state of the plurality of identity graphs;
determining, based on a timestamp of the edge associated with the record that is more recent than a different timestamp of a different edge of the plurality of edges, to apply the edge to the temporary state before the different edge;
determining, based on applying the edge associated with the record to the temporary state, a non-collapsed state of the plurality of identity graphs comprising the edge;
determining, based on applying the different edge to the temporary state comprising the edge and resulting in the collapsed state, to prune the different edge from the non-collapsed state; and
causing updating of a corresponding profile based on the non-collapsed state and the record.

9. The media of claim 8, the method further comprising:
subsequent to applying a non-incident edge to the temporary state that is non-incident to the identity node associated with the incoming record, applying the edge associated with the incoming record to the temporary state comprising the non-incident edge.

10. The media of claim 8, the method further comprising:
determining to apply the different edge to the temporary state before a subsequent different edge based on a corresponding priority value that is less than the priority value of the different edge.

11. The media of claim 8, the method further comprising:
determining to apply the different edge to the temporary state before a subsequent different edge based on a corresponding priority value that is equal to the priority value of the different edge and a corresponding timestamp that is less recent than the different timestamp of the different edge.

12. The media of claim 8, the method further comprising:
determining a priority value of the different edge based on each corresponding priority value of each corresponding identity node connected by the different edge.

13. The media of claim 8, the method further comprising:
determining the collapsed state based on an identity namespace limit above a limit; and
determining the non-collapsed state based on the identity namespace limit within the limit.

14. The media of claim 8, the method further comprising:
accessing the record, the record comprising customer data corresponding to an identity value and an identity namespace of the identity node, the timestamp corresponding to the edge, and interaction data; and
further causing updating of the corresponding profile based on the interaction data.

15. A computing system comprising:
a processor; and
a non-transitory computer-readable medium having stored thereon instructions that when executed by the processor, cause the processor to perform operations including:
determining, based on applying an identity node and an edge associated with an incoming record to a plurality of identity graphs, a collapsed state of the plurality of identity graphs, each identity graph of the plurality of identity graphs corresponding to a data structure mapping relationships between identities;
determining, based on pruning a plurality of edges of the collapsed state, a temporary state of the plurality of identity graphs;
determining, based on applying the edge associated with the incoming record to the temporary state, a non-collapsed state of the plurality of identity graphs comprising the edge;
determining, based on applying a different edge of the plurality of edges to the temporary state comprising the edge and resulting in the collapsed state, to prune the different edge from the non-collapsed state; and
causing updating of a corresponding profile based on the non-collapsed state and the incoming record.

16. The system of claim 15, wherein the instructions that when executed by the processor, cause the processor to perform operations further including:
subsequent to applying a non-incident edge to the temporary state that is non-incident to the identity node associated with the incoming record, applying the edge associated with the incoming record to the temporary state comprising the non-incident edge.

17. The system of claim 15, wherein the instructions that when executed by the processor, cause the processor to perform operations further including:
determining to apply the different edge to the temporary state before a subsequent different edge based on a corresponding priority value that is less than the priority value of the different edge.

18. The system of claim 15, wherein the instructions that when executed by the processor, cause the processor to perform operations further including:
determining to apply the different edge to the temporary state before a subsequent different edge based on a corresponding priority value that is equal to the priority value of the different edge and a corresponding timestamp that is less recent than a timestamp of the different edge.

19. The system of claim 15, wherein the instructions that when executed by the processor, cause the processor to perform operations further including:
determining a priority value of the different edge based on each corresponding priority value of each corresponding identity node connected by the different edge.

20. The system of claim 15, wherein the instructions that when executed by the processor, cause the processor to perform operations further including:
determining the collapsed state based on an identity namespace limit above a limit; and
determining the non-collapsed state based on the identity namespace limit within the limit.
